(19) United States
(12) Patent Application Publication
(10) Pub. No.: US 2015/0298999 A1
(43) Pub. Date: Oct. 22, 2015

(54) WATER TREATMENT SYSTEM

(71) Applicant: Purewater Therapeutics, LLC, Longmont, CO (US)

(72) Inventors: Mark Forrest Smith, Longmont, CO (US); W. Mark Davis, Louisville, CO (US); Justin Charles Smith, Broomfield, CO (US)

(73) Assignee: Purewater Therapeutics, LLC

(21) Appl. No.: 14/691,768

(22) Filed: Apr. 21, 2015

Related U.S. Application Data
(60) Provisional application No. 61/982,473, filed on Apr. 22, 2014.
(60) Provisional application No. 62/046,626, filed on Sep. 5, 2014.

(51) Int. Cl. C02F 1/469; C02F 1/44

(52) U.S. Cl. CPC C02F 1/4691; C02F 1/444; C02F 2303/04; C02F 2201/008; C02F 2201/46105

(57) ABSTRACT

A water purification system is disclosed. An example of the water purification system includes a transportable water machine to generate purified water. The example transportable water machine includes fluid treatment subsystems including at least a pre-treatment subsystem, a Capacitive Deionization (CDI) subsystem, a mix and filter subsystem, and an output subsystem. The example transportable water machine also includes a mechanical subsystem to support the pre-treatment subsystem, CDI subsystem, mix and filter subsystem, and the output subsystem. The example transportable water machine also includes an electrical subsystem to support the pre-treatment subsystem, CDI subsystem, mix and filter subsystem, and the output subsystem. in an example, influent (e.g., tap water) to the water purification system is passed through one or more filter (e.g., a series of filters) to remove large particles, ions, organic molecules, inorganic molecules, and biological material.

### CROSS REFERENCE TO RELATED APPLICATION

This application claims the priority benefit of U.S. Provisional Patent Application No. 61/982,473 filed Apr. 22, 2014 for “Water Purification System,” and U.S. Provisional Patent Application No. 62/046,626 filed Sep. 5, 2014 for “Combined Water Purification System And Waste Handling System,” each hereby incorporated by reference in its entirety as though fully set forth herein.

### BACKGROUND

Medical fluids need to be highly purified to remove chemical and biological contaminants. A typical hemodialysis procedure requires 150 liters of purified water. There are over 2,000,000 patients receiving hemodialysis treatment worldwide in 2015. Therefore, nearly 47 billion liters of purified water will be required to treat patients with chronic kidney disease. This water is presently supplied by bagged fluid, industrial water purification systems (for multiple patients concurrently), or portable water purification systems (for one or two patients). Reverse osmosis and distillation are the primary methods of water purification for hemodialysis. Both processes requirement large amounts of energy.

Reverse osmosis is the most commonly used water purification method. It was commercialized in the 1970s and has been incrementally improved over the years. Today's systems are anywhere from 25-50% efficient, meaning the systems produce 1-3 liters of waste fluid for every liter of clean fluid. Reverse osmosis also requires a significant amount of energy. Most portable water purification systems that employ reverse osmosis water purification require at least 500W of electrical power.

### BRIEF DESCRIPTION OF THE DRAWINGS

FIG. 1 is an illustration of an example transportable water treatment system.

FIG. 2 illustrates an example pre-treatment subsystem of the example water treatment system shown in FIG. 1.

FIG. 3 illustrates an example capacitive deionization (CDI) subsystem of the example water treatment system shown in FIG. 1.

FIG. 4 illustrates an example mix and filter subsystem of the example water treatment system shown in FIG. 1.

FIG. 5 illustrates an example output subsystem of the example water treatment system shown in FIG. 1.

FIG. 6 illustrates an example filter station mechanical subsystem of the example water treatment system shown in FIG. 1.

FIG. 7 illustrates an example filter station electrical subsystem of he example water treatment system shown in FIG. 1.

### DETAILED DESCRIPTION

A water treatment (or purification) system is disclosed as it may be implemented to purify water. In an example, influent (e.g., tap water) to the water purification system is passed through one or more filter (e.g., a series of filters) to remove large particles, ions, organic molecules, inorganic molecules, and biological material. Although not limited in end-use, the system may be configured to further combine the purified water with medical solution concentrate, store the solution, and then dispense the product, e.g., via a medical device for use in a medical treatment procedure and/or surgery.

The Environmental Protection Agency (EPA) defines Primary Drinking Water according to the National Primary Drinking Water Regulations, as suitable for human consumption. While EPA Primary Drinking Water (often referred to as “tap” water) is suitable for human consumption, this water has not been sufficiently purified to meet the standards for medical use. The system disclosed herein receives tap water as influent, and discharges purified water as effluent. The effluent may meet and/or exceed standards for medical use, In an example, the effluent may be used as an irrigation fluid that meets and/or exceed USP standards.

The system may be configured for end-use according to a variety of form factors. By way of non-limiting illustration, the system may be configured as a mobile (e.g., “suitcase”) version, a clinical version, an Intensive Care Unit (ICU) version, and a home-use version, to name only a few examples.

It is noted that as used herein, the terms “includes” and “including” mean, but is not limited to, “includes” or “including” and “includes at least” or “including at least.” The term “based on” means “based on” and “based at least in part on,” The term “logic” includes, but is not limited to, computer software and/or firmware and/or hardwired configurations. The term “software” includes logic implemented as computer readable program code and/or machine readable instructions stored on a non-transitory computer readable medium for media) and executable by a processor and/or processing unit(s).

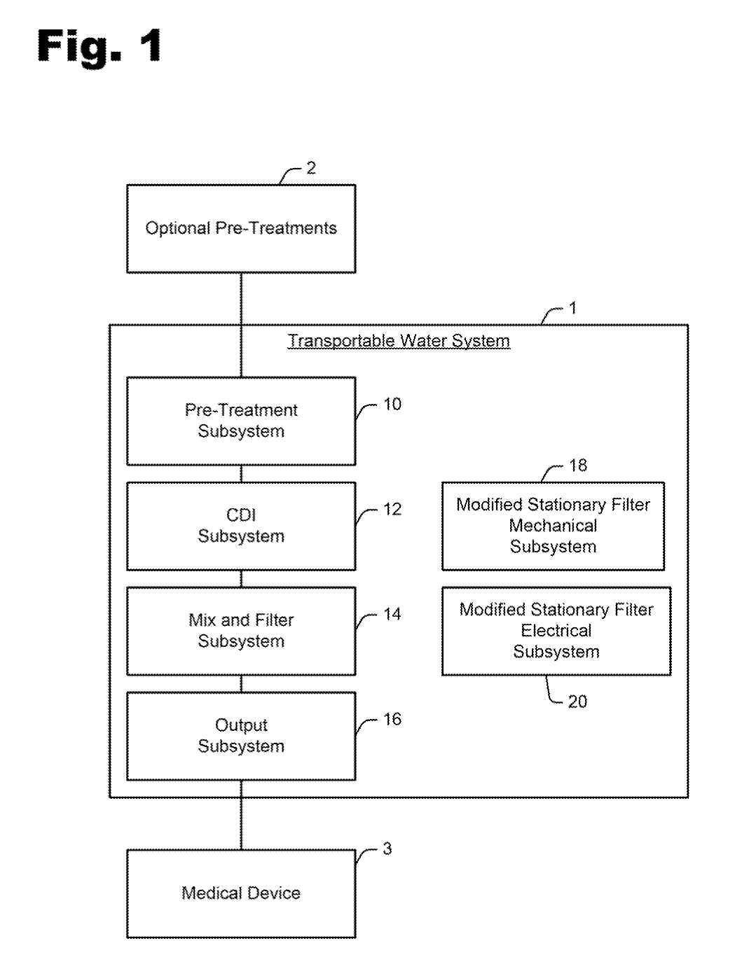

FIG. 1 is an illustration of an example transportable water treatment (or purification) system 1. An example of the system 1 generates fluid on-demand. That is, the system 1 can be operated to generate treated fluid as the fluid is desired or used. In another example, the system 1 may generate fluid in advance, e.g., for use at a later time.

An example system 1 is light weight, small, low power, low waste water, and easy to use. For example, the system 1 may be used in a hospital environment. Another example of the system 1 may be ruggedized (highly reliable), e.g., for frequent transport or rough environments (military, remote medical missions, etc.).

The system 1 may be configured to generate pure water or mixed solutions, for example, for use with a medical device 3 such as a hemodialysis machine. Other medical devices and/or uses for the output are also contemplated and are not limited to any particular end-use.

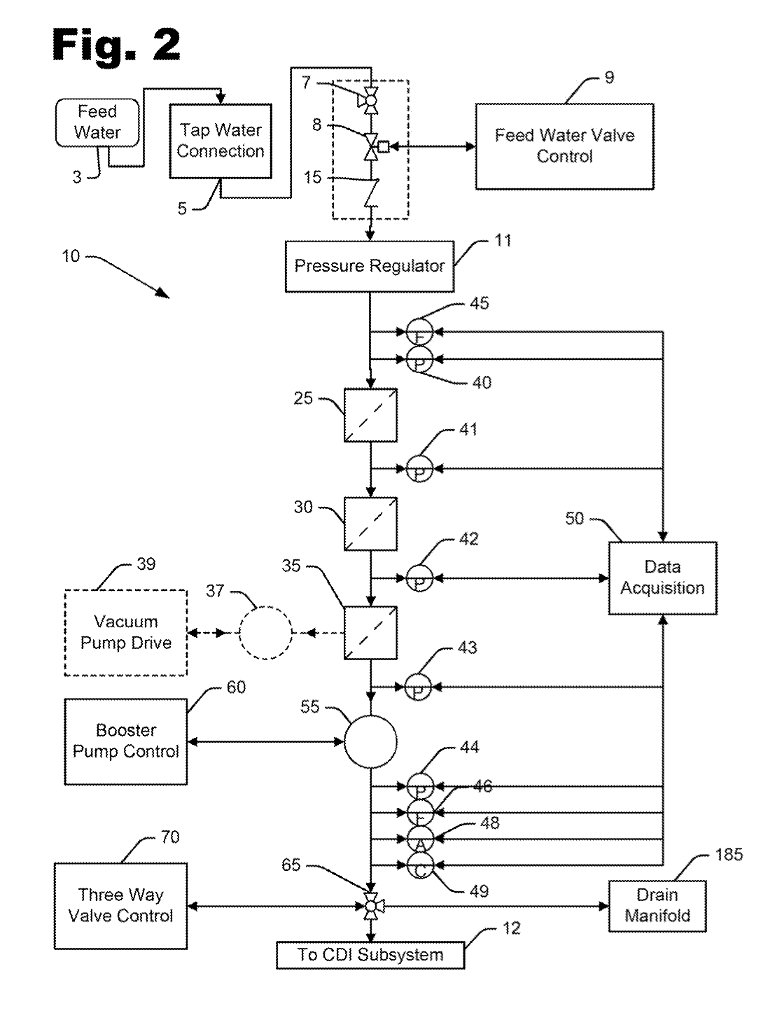

An example system 1 comprises optional pre-treatments 2, pre-treatment subsystem 10, capacitive deionization (CDI) subsystem 12, mix and filter subsystem 14, and output subsystem 16. In an example, the system may also include a modified stationary filter mechanical subsystem 18 and/or a modified stationary filter electrical subsystem 20. These and other example components of the system 1 are described below in more detail with reference to the illustrations of FIGS. 2-7.

Before continuing, it is noted that additional and/or fewer subsystems than shown in FIG. 1 may be implemented. For example, the transportable system may not include certain elements of the concentrate mixing function described in the mix and filter subsystem 14, if the system 1 is used as a water purifier and not as a concentrator of medical fluids. In addition, the subsystems shown in FIG. 1 may be combined with other subsystems, and/or the subsystems shown in FIG. 1 may be provided as further subsystems. The illustration of FIG. 1 is merely exemplary and not intended to be limiting in any manner. That is, the example configurations described above are provided for purposes of illustration, and are not intended to be limiting. Other components and/or device configurations may be utilized to carry out the operations described herein.

FIG. 2 illustrates an example pre-treatment subsystem 10. Subsystem 10 receives feed water and pre-filters it in preparation for subsequent filtration steps.

An example subsystem 10 includes (optional) pre-treatment filters, (optional) booster pump, feed water 3, tap water connection 5, manual three-way valve 7, feed water valve 8, feed water valve control (e.g., circuits and logic) 9, backflow prevention valve 15, pressure regulator 11 (e.g., to set pressure greater than about 10 psi and less than about 150 psi, sediment filter 25 (e.g., having a pore size less than or equal to about 10 microns and replaceable at regular intervals or when needed), an ultrafilter 30 (e.g., having a pore size less than or equal to about 0.22 microns, and replaceable at desired intervals or when needed), air removal filter 35, vacuum pump 37 (e.g., providing a vacuum level greater than or equal to about 1.0 inches of mercury), vacuum pump control (e.g., circuits and logic) 39.

The subsystem 10 may also include pressure sensors 40, 41, 42, 43, 44 (e.g., pressure range of about 0-150 pounds per square inch, and resolution at least about ±1 pounds per square inch), flow sensors 45, 46 (e.g., flow range of about 0-5 liters per minute, and resolution at least about ±0.1 liters per minute), air in line sensor 48 (e.g., having a range of about 1-1000 microliter bubbles, and a resolution of less than or equal to about 5 microliters), conductivity sensor 49 (e.g., having a conductivity range of about 0-2000 micro Siemens per centimeter, and resolution less than or equal to about ±5 micro Siemen per centimeter), data acquisition (e.g., circuits and logic) 50, booster pump 55 (e.g., capable of a pressure head greater than about 50 pounds per square inch, and flow rate greater than about 0.5 liters per minute), booster pump control (e.g., circuits and logic) 60, three way valve 65, three way valve control (e.g., circuits and logic) 70, and drain manifold 185.

In an example, the tap water connection 5 connects the device to a tap water source which seals the fluid path and introduces feed water 3 to the device. If the feed water 3 does not meet the EPA Primary Drinking Water standards, then pre-treatment filters 1 may be implemented to reduce contaminants in the water.

In an example, a manual three way valve 7 is provided after the tap water connection to enable the user to shut-off or divert water flow to the device during installation, maintenance, or safety reasons.

Feed water flows through the automated feed water valve 8, which enables the machine to control the ingress of feed water. This may be closed during installation, maintenance, or when flow is not needed. The valve is controlled and driven by the feed water control (e.g., circuits and logic) 9. The feed water enters a backflow prevention valve 15 which keeps fluid in the system from flowing back in to the feed water supply 3 or 5. The feed water then flows through a pressure regulator 11, which prevents over-pressure in the system. If the feed water is not sufficiently pressurized, a booster pump may be implemented in the feed water system before the tap water connection 5 to increase pressure. A flow sensor 45 is located after the pressure regulator to determine the flow of the feed water. The sensor output is captured by the data acquisition (e.g., circuits and logic) 50.

In an example, a pressure transducer 40 is in fluid communication with the fluid path after the regulator to monitor the inlet feed water pressure. The sensor output can be captured by the data acquisition (e.g., circuits and logic) 50.

The feed water then enters a sediment filter 25 with pore size less than or equal to 10 micron. This filter reduces chemical and biological contaminants and prevents large particles from fouling downstream filters. The sediment filter is replaceable at various intervals,

In an example, a pressure transducer 41 is located after the sediment filter. The pressure drop through the sediment filter, as referenced to the pressure transducer 40, is monitored over time to determine the life of the filter. Fouling in the filter causes the pressure drop to increase. The sensor output is captured by the data acquisition (e.g., circuits and logic) 50.

The feed water then flows through an ultrafilter 30 with pore size less than or equal to about 0.22 micron. The filter removes bacteria, virus, and endotoxin from the feed water. The ultrafilter is replaceable at various intervals.

In an example, a pressure transducer 42 is in fluid communication with the feed water after the ultrafilter 30. The pressure drop across the ultrafilter, as referenced to the pressure transducer 41, is monitored over time to determine the life of the filter, The sensor output is captured by the data acquisition (e.g., circuits and logic) 50. The feed water then flows through an air removal filter 35 to remove air and gas. The air removal filter is replaceable at various intervals.

In an example, a vacuum pump 37 may be attached to the air removal filter to enhance air removal by drawing a vacuum in the filter. The vacuum pump is driven and controlled by the vacuum pump drive (e.g., circuits and logic) 39.

In an example, a pressure transducer 43 is in fluid communication with the feed water after the air removal filter 35. The pressure drop across the air removal filter, as referenced to the pressure transducer 42, is monitored over time to determine the life of the filter. The sensor output is captured by the data acquisition (e.g., circuits and logic) 50.

The feed water then enters a booster pump 55, which may be positive displacement or centrifugal pump, in order to increase the pressure of the fluid stream after the pressure drops in the degassing, sediment, and ultra- filters. The booster pump is driven and controlled by the booster pump control (e.g., circuits and logic) 60.

In an example, a pressure sensor 44 is located after the booster pump to determine the pressure of the water stream. The sensor output is captured by the data acquisition (e.g., circuits and logic) 50.

In an example, a flow sensor 46 is in-line with the flow to determine the flow rate of feed water. The sensor output is captured by the data acquisition (e.g., circuits and logic) 50.

In an example, an air in line sensor 48 measures the quantity of air in the water stream. The sensor output is captured by the data acquisition (e.g., circuits and logic) 50.

In an example, a conductivity sensor 49 is located before the three way valve 65 in order to measure the ion content in the water stream. The sensor output is captured by the data acquisition (e.g., circuits and logic) 50.

The treated water then enters an automated three-way valve 5. The valve is driven and controlled by the valve control (e.g., circuits and logic) 70.

In an example, logic may be configured as follows. The flow 46 and pressure 44 sensors provides feedback for the booster pump. If flow or pressure is too low, the booster pump input may be increased. If the flow or pressure is too high, the booster pump input may be decreased. If the processor determines the water needs to be diverted to drain, the valve is activated and flow is diverted to the drain manifold 185. Otherwise, the water flows to the CD Chamber Subsystem.

The system may be put in an installation or maintenance mode where water is diverted to the drain by the three way valve 65 for a predetermined period of time or until it meets certain pressure, flow, or air parameters.

In other examples, an additional booster pump is provided before entering the tap water connection 5. In the event the feed water pressure is low, a booster pump may be provided to get adequate flow through the Pre-Treatment Subsystem. With additional filtering pre-treatment before entering the tap water connection If the water has a high presence of a particular chemical or particulate, additional pre-treatment before the system may be implemented. Without the air removal filter 35. This filter may not be implemented and may be an optional pre-treatment. With a shutoff valve rather than a three way valve 65 and drain connection 185 at the end of the subsystem.

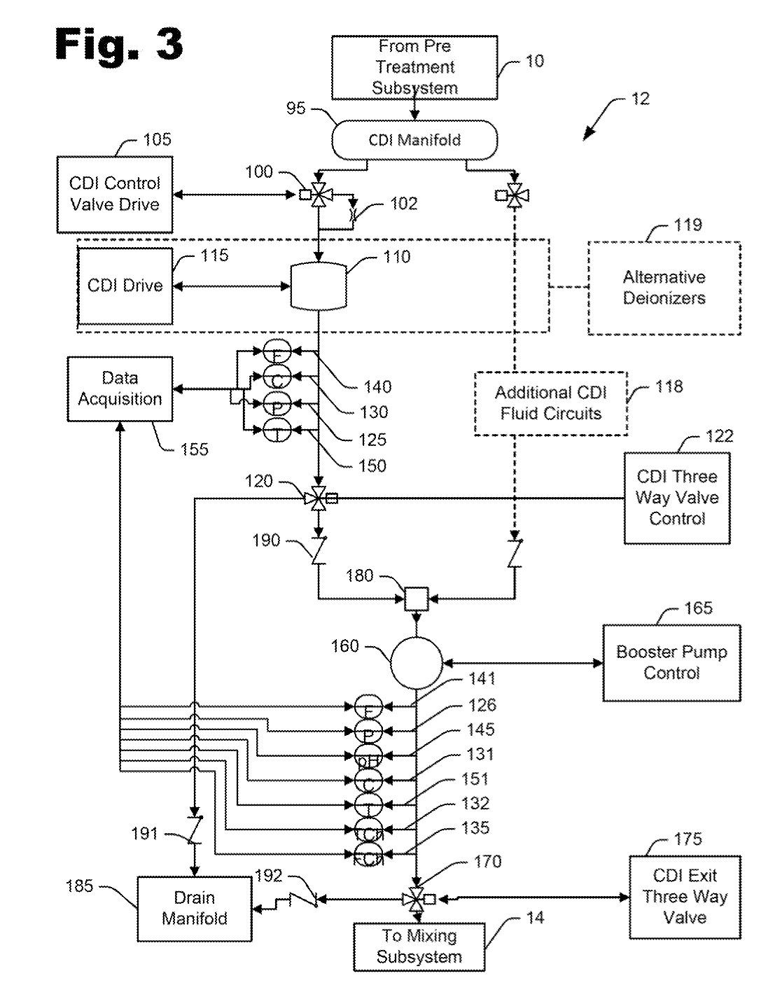

FIG. 3 illustrates an example capacitive deionization (CDI) subsystem 12. The CDI subsystem 12 receives the output of the pre-treatment subsystem 10 and then removes ions and chemicals from the water.

In an example, the CDI subsystem 12 may include CDI manifold 95, CDI control valves 100, CDI flow restrictor 102 (e.g., flow rate reduced at least about 50% when compared to high flow fluid path), CDI control valve drive (e.g., circuits and logic) 105, CDI chamber 110 (e.g., flow rate at least about 250 milliliters per minute while purifying to about 1.0 micro Siemens per centimeter), CDI drive (e.g., circuits and logic) 115, additional CDI fluid circuits 118, alternative deionizers 119, CDI three way valve(s) 120, CDI three way valve drive (e.g.,, circuits and logic) 122, pressure sensors 125, 126 (e.g., pressure range about 0-150 pounds per square inch, and resolution less than or equal to about ±1 pounds per square inch), conductivity sensors 130, 131 (e.g., conductivity range at least about 0-200 micro Siemens per centimeter, and resolution less than or equal to about ±0.25 micro Siemens per centimeter).

In an example, the CD subsystem 12 may also include Total Chlorine Sensor 132 (e.g., range of about 0-20 parts per million, and resolution less than or equal to about 0.1 parts per million), free chlorine sensor 135 (e.g., range of about 0-20 parts per million, and resolution less than or equal to about 0.1 parts per million), flow sensors 140, 141 (e.g., flow range of about 0-0.5 liters per minute, and resolution less than or equal to about ±0.1 liters per minute), pH sensor 145 (e.g., pH range of about 0-14 pH units, and resolution less than or equal to about ±0.25 pH units), temperature sensor(s) 150, 151 (e.g., temperature range of about 0-100° C. and resolution less than or equal to about ±1° C.), data acquisition (e.g., circuits and logic) 155, booster pump 160 (e.g., pressure head capable of greater than about 50 pounds per square inch, and flow rate greater than about 5 liters per minute), booster pump control (e.g., circuits and logic) 165, CD exit three way valve 170, CDI exit valve control logic 175, deionized water manifold 180, drain manifold 185, and check valves 190, 191, 192.

The pre-treated water enters the CDI Subsystem 12 from the pre-treatment subsystem 10. The CD manifold 95 divides the flow in to one or more fluid paths. An example fluid path is shown in the figure, but CDI fluid circuits 118 comprising the fluid circuit description below may be added.

The CDI fluid circuit is described as follows. Fluid enters the CD control valve 100. The control valve is automated and has three states: no flow, low flow, or high flow. The CDI control valve drive circuits and control logic 105 control the state of the valve and drive its movement. In the no flow state, the valve blocks flow to the remainder of the CDI fluid circuit. This may occur when the machine is not in use or during maintenance. In the low flow state the valve diverts flow through the CDI flow restrictor 102 and in to the CDI chamber 110. This may occur during regeneration of the CD chambers. In the high flow state, the valve diverts flow directly to the CDI chamber 110. This may occur in a deionizing mode, maintenance, filter replacement, or regeneration.

In an example, the CDI chamber 110 the fluid is deionized. The deionization chambers may be made from carbon material (activated carbon fiber, granular activated carbon, block granular activated carbon, aerogel, reticulated vitreous carbon, etc.). Water flows through the electrodes. Two electrodes of opposite charge create an electromagnetic field where ions and charged chemicals are attracted to either the positive or negative electrode. The charge is generated by connection with a DC power supply. A differential voltage of between about 1.2 and 10 Volts is applied to the electrodes. The voltage may vary, depending on the position in the electrode stack. The electrodes are encased in a non-leaching polymer housing. The electrodes are spaced by a polymer mesh or spacer. The spacing between electrodes may vary with position in the stack.

In an example, the CDI chamber voltage is driven and controlled by the CDI drive (e.g., circuits and logic) 115. Once the fluid leaves the CDI chamber, four sensors monitor physical properties of the water: pressure 125, conductivity 130. temperature 150, and flow 140. The sensor output is captured by the data acquisition (e.g., circuits and logic) 155,

After the sensors, the CDI three way valve 120 may divert flow between two paths. in an example, the first path is through a check valve 191 and in to the drain manifold 185. The check valve prevents fluid intended for disposal from re-entering the CDI fluid circuit. An example second path is through a check valve 190 and in to the deionized water manifold 180, where water continues through the fluid circuit of the stationary filter system to the mixing subsystem. The check valve prevents water from another CDI fluid circuit from entering the fluid circuit.

After the deionized water manifold 180, the water passes through a booster pump 160, The booster pump control (e.g., circuits and logic) 165 drive the booster pump. The booster pump increases pressure of the fluid in the system after the CDI chambers.

The deionized water then enters the following sensors: flow sensor 41 (to determine the flow of the water); pressure sensor 126 (to determine the, pressure of the water); pH sensor 145 (to determine the acidity/alkalinity of the water); conductivity sensor 131 (to determine the ion/chemical content and conductivity of the water); temperature Sensor 151 (to determine the temperature of the water); total chlorine sensor 132 (to determine the total amount of chlorine in the water); and free chlorine sensor 135 (to determine the amount of free chlorine in the water). The data acquisition module (e.g., circuits and logic) 155 converts data from analog to digital and communicates the measurements to the processor.

In an example, the CDI exit three way valve 170 diverts flow between two paths. The first path is through a check valve 192 to the drain manifold 185. The check valve prevents fluid intended for disposal from re-entering the CDI fluid circuit. The second path is to the Mixing Subsystem. The CDI exit three way valve 170 is controlled by the CDI exit three way valve control (e.g., circuits and logic) 175.

Logic may include the following. The CDI control valve 100 diverts water through either the high or low flow fluid paths, depending on the needs of the system. The CDI drive (e.g., circuits and logic) 115 provide power to the electrodes. This may be in sequential steps or all at once.

Based on the measurements from the deionized water output sensors 125, 130, 140, 150, the power to the CDI chamber drive may he manipulated by the CDI drive (e.g., circuits and logic) 115. Until the deionized water meets specification, as determined by the data from the sensors 125, 130, 140. 150, the CDI three way valve 120 diverts flow to the drain manifold 185.

Once the deionized water meets specification, as determined by the data from the sensors 125, 130, 140, 150, the CDI three way valve 120 diverts flow to the deionized water manifold 180. If at any point the water does not meet specification, then the CDI three way valve 120 is switched back to the drain manifold exit position.

Once the electrodes reach capacity (electrode surface is covered so that no more ions/chemicals may attach) and the specification is no longer being met, the CDI three way valve 120 immediately diverts the flow to the drain manifold 185 and the CDI chamber 110 goes in to regeneration mode. During regeneration mode, the CDI drive (e.g., circuits and logic) 115 manipulate power to the electrodes causing ions/chemicals to desorb from the electrode surfaces. The waste flow is diverted to the drain manifold 185 by the CDI three way valve 120. During regeneration, the flow path may be diverted by the CDI control valve 100 to the high flow or low flow 102 circuits, depending on the regeneration needs,

Once regeneration criteria have been satisfied (e.g., based on electrode current, electrode voltage, and/or conductivity of effluent, etc.), the system may either go in to a rest mode (no flow) or return to a purification mode.

In an example, variations of the subsystem 12 are also contemplated. By way of non-limiting illustration, there may be one or multiple CD fluid circuits, drive circuits, and logic 118. An accumulator tank may be added in the CDI circuit. A tank of less than about 100 liter volume may be filled with sterilized feed water (from the pre-treatment subsystem 10. The CDI circuit may draw from the tank, deionize the water, and circulate it back in to the tank until the conductivity, chlorine, chloramine, and pH of the bulk fluid was at an acceptable level. The fluid may then be pumped in to the Deionized Water Manifold.

In an example, the CDI chamber may be replaced by a deionizing system 119, including but not limited to, reverse osmosis, electrodialysis, electrodeionization, and charged ion beds. The CDI chamber electrode configuration may be flow-by electrodes instead of flow-through electrodes. The electrodes in the CDI chamber 110 may have current passed across each one, instead of from one electrode to the next across the gap (as a capacitor), For example, the internal resistance of the electrode may cause it to heat up. When fluid flowed through the electrode, the temperature may raise due to conductive and convective heat transfer from the electrode. Heating the fluid above a certain temperature threshold may enable for disinfection of the system and more effective regeneration. Electrodes may be used to heat fluid during purification to create a sterile solution at a specified temperature.

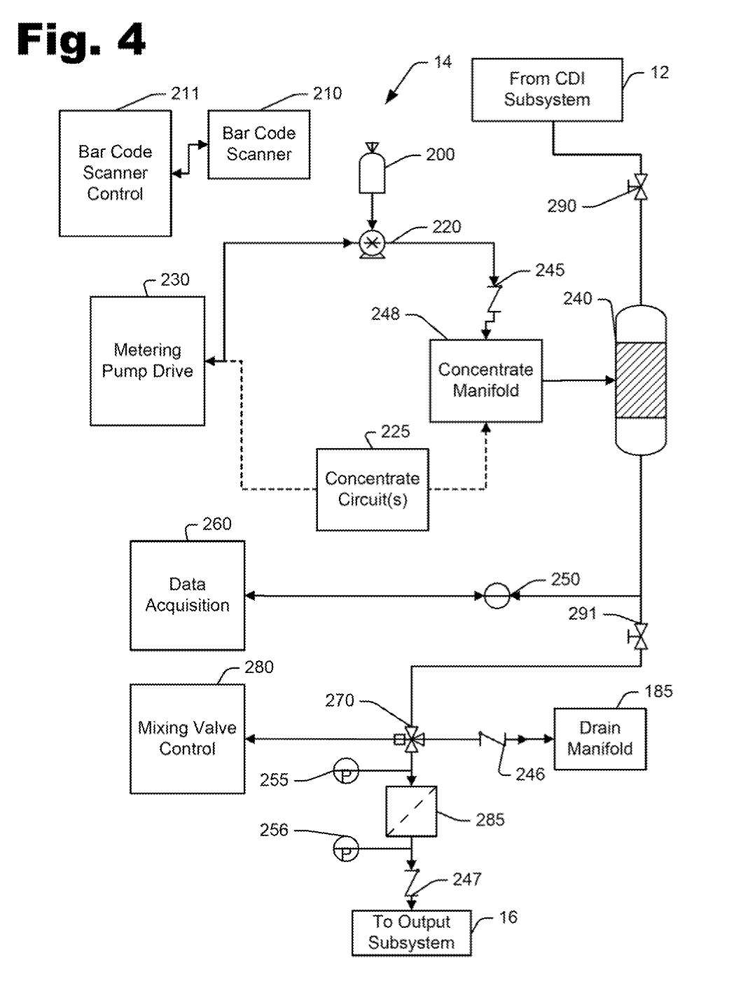

FIG. 4 illustrates an example mix and filter subsystem 14. Subsystem 14 may combine concentrate with deionized water to form a fluid of specified concentration and then removes bacteria, virus, and endotoxin from the solution by ultrafiltration.

In an example, the mix and filter subsystem 14 may receive water from the CD subsystem 12 and may include one or more containers of concentrate solution 200 (e.g., volume greater than about 500 milliliters), barcode scanner 210, bar code scanner control (e.g., circuits and software) 211, metering pump 220 (e.g., flow rate range of about 0-250 milliliters per minute, and pressure head capable of greater than or equal to about 50 pounds per square inch), additional concentrate circuits 225, metering pump control (e.g., circuits and logic) 230, mixing chamber 240, check valves 245, 246, 247, concentrate manifold 248, conductivity sensor 250 (e.g., conductivity range of about 0-40,000 micro Siemens per centimeter, and resolution less than or equal to about 100 micro Siemens per centimeter), data acquisition 260, mixing valve 270, mixing valve control logic 280, drain manifold 185, sample port 290, 291, and ultrafilter 285 (e.g., having a pore size less than or equal to about 0.22 microns).

Water (dilutant) from the CDI subsystem 12 enters the mix and filter subsystem 14. The fluid from the CDI Subsystem 12 passes through a sample port 290. The sample port 290 may be a push button port with a spout the can be easily accessed for filling a sample container. This may be implemented for capturing samples of fluid for water quality tests. The dilutant enters the mixing chamber 240. The mixing chamber may be a separate volume or simply a stretch of tubing.

In an example, a barcode scanner 210 convenient to the user is employed to read information from the concentrate solution labeling. Information may include solution description, concentration, lot number, or expiration date. The bar code scanner is controlled by the bar code scanner control (e.g., circuits and logic) 211.

Concentrate is added to the mixing chamber by one or more of the concentrate circuits 225. In an example, each of the concentrate circuits include one or more containers of medical solution concentrate 200 connected to the metering pump 220. The concentrate may be of injection, irrigation, hemodialysis, hemofiltration, hemodiafiltration, or other medical fluids. The metering pump 220 apportions the concentrate solution 200 in to the mixing chamber 240. The metering pump 220 is driven and controlled by the metering pump control (e.g., circuits and logic) 230. The concentrate exits the metering pump 220 and enters a check valve 245. The check valve 245 prevents concentrate or dilutant from flowing back in to the metering pump 220 and concentrate container 200.

After exiting the check valve 245, the concentrate enters the concentrate manifold 248. The concentrate manifold 248 accepts one or more concentrate fluid circuits 225 and creates a fluid path in to the mixing chamber 240. The concentrate and dilutant enter the mixing chamber 240 where the solutions are mixed.

After exiting the mixing chamber 240, the fluid passes a conductivity sensor 250 for a check of the solution's conductivity against known values for the desired solution and concentrate. In an example, data acquisition (e.g., circuits and logic) 260 capture the conductivity measurement from the sensor and store the value in memory for access by the system logic.

The fluid passes through a sample port 291. The sample port 291 may be a push button port with a spout the can be easily accessed for filling a sample container. This may be implemented for capturing samples of fluid for water quality tests. The fluid exits the sample port 291 and enters a three way valve, the mixing valve 270. The three way valve 270 has two positions. The first directs the flow to the drain manifold 185. The second directs the flow to the Output Subsystem.

After exiting the mixing valve 270, the solution passes through a check valve 246 before entering the drain manifold 185. This valve prevents fluid intended for disposal from re-entering the subsystem. After exiting the mixing valve 270, the solution enters the ultrafilter 285, the solution enters the ultrafilter, which removes bacteria, virus, and endotoxin. The diameter of the pores is less than 0.22 micron. The solution exits the ultrafilter 285 and enters a check valve 247, which prevents fluid from being pushed back in to the Mix and Filter Subsystem.

Example logic may be implemented at least in part as computer software and/or firmware and/or hardwired. The system logic communicates with the flow sensors in the CDI subsystem 12 to determine the correct flow rate of concentrate 200, and by calculation the speed of the metering pump 220. The flow rate of the concentrate solution is based on the measured flow rate of the dilutant, the desired concentration of solution, and the concentration of the concentrate (from the barcode scanner logic).

In an example, the system logic reads the critical information from the barcode scanner 210 and logic 211. This data may be logged to determine the appropriate concentration of fluid, and therefore the speed of the metering pump.

In an example, conductivity of the solution, as measured by the conductivity sensor 250, is compared against known values for the desired concentration of solution. If the conductivity is in the acceptable range, the mixing valve 270 enables the fluid to continue to the output subsystem. If the fluid fails the conductivity test, the mixing valve 270 directs the fluid to the drain manifold 185. If the fluid is found unacceptable for a significant period of time, the user is alerted. The default position of the mixing valve 270 is open to the drain manifold 185.

Other example configurations may include any sort of non-contact identification (e.g. optical or RFID) of the concentrate solution instead of a barcode scanner 210, 211. This may include QR codes, 1D barcodes, visual symbols by image detection, etc. This subsystem may be included if the purpose of the machine is solely to generate sterile water. The check valve 245, concentrate manifold 248, and mixing chamber 240 may be one integrated physical unit. The addition of a booster pump may be provided before the ultrafilter in order to boost pressure and flow through the filter and then the output subsystem 16,

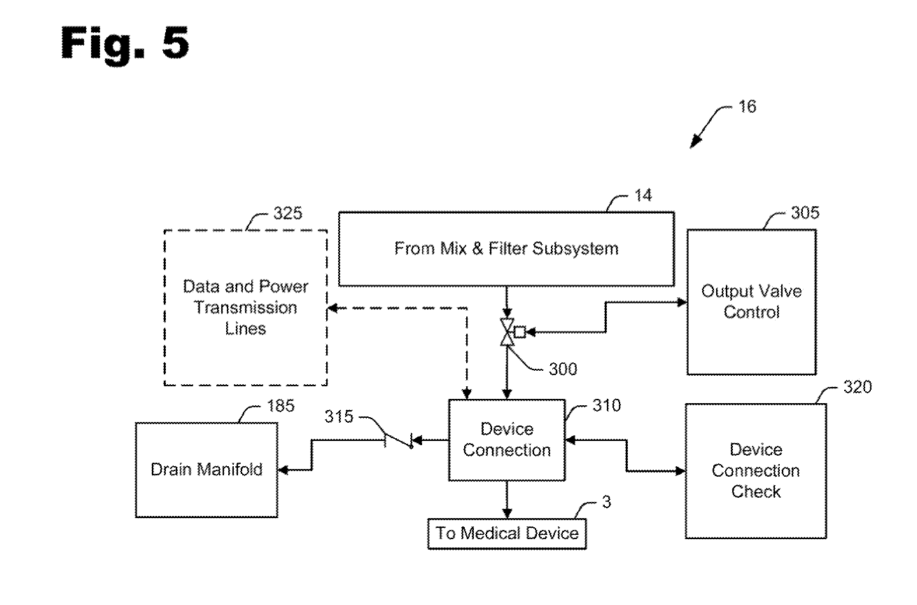

FIG. 5 illustrates an example output subsystem 16. In an example, the output subsystem 16 connects to the medical device (e.g., a hemodialysis machine), to transfer the fluid from the transportable water purification system to the medical device.

In an example, the output subsystem may receive sterile solution from mix and filter subsystem 14. The output subsystem 16 may include output valve 300, output valve control (e.g., circuits and logic) 305, device connection 310, check valve 315, device connection check (e.g., circuit and logic) 320, and drain manifold 185.

Sterile solution enters the output subsystem 16 from the mix and filter subsystem 14 via output valve 300. The valve 300 controls the flow of fluid between the stationary filter and the mobile tank, The output valve control (e.g., circuits and logic) 305 control and drive the valve 300 based on commands from the control logic.

In an example, the solution then enters the device connection 310. The device connection 310 may include a sterile fluid connection (directing sterile solution from the transportable water purification system to the medical device), means for determining the device connection is complete, device connection check circuit and logic, and means for protecting the connection's exposure to fluid and air when not in use.

Logic may be implemented at least in part as computer software and/or firmware and/or hardwired. The logic waits for confirmation from the device connection check circuit and logic to open the valve for solutions.

In other examples, variations may include a UV light may be added in the protective covering over the device connection 310. The UV light neutralizes bacteria and virus, and denatures endotoxin prior to connection with the Mobile Tank. Data and power transmission lines 325 may be used to communicate with or power a medical device.

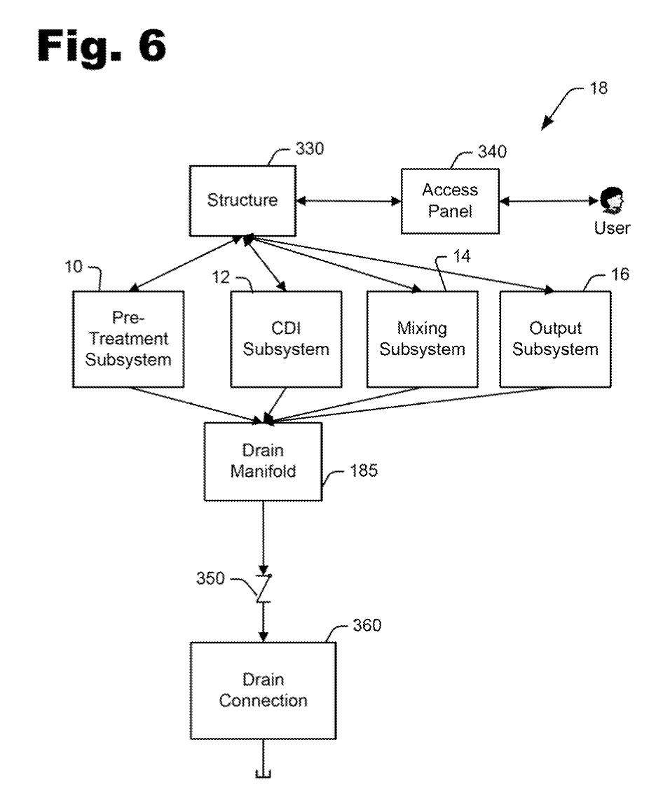

FIG. 6 illustrates an example mechanical subsystem 18, This subsystem provides a means for supporting all other subsystems and fastening them to a transportable enclosure. In an example, the filter station mechanical subsystem 18 includes structure 330, access panel 340, drain manifold 185 (e.g., flow rate to drain at least about 2 liters per minute), check valve 350, and drain connection 360.

In an example, the structure 330 enables points of connection to support the other subsystems in the system 1. Access panel 340 enables access to the subsystems for installation and maintenance. Access panel 340 and associated housing also protects the subsystems from the environment around the system. The drain manifold 185 provides a point of connection for all the subsystems that direct fluid to the drain. It contains many inputs and one output to the check valve 350. The check valve prevents drain fluids from re-entering the system. The drain fluid exits the check valve 350 and enters the drain connection 360 where it is flushed in the facility's drain.

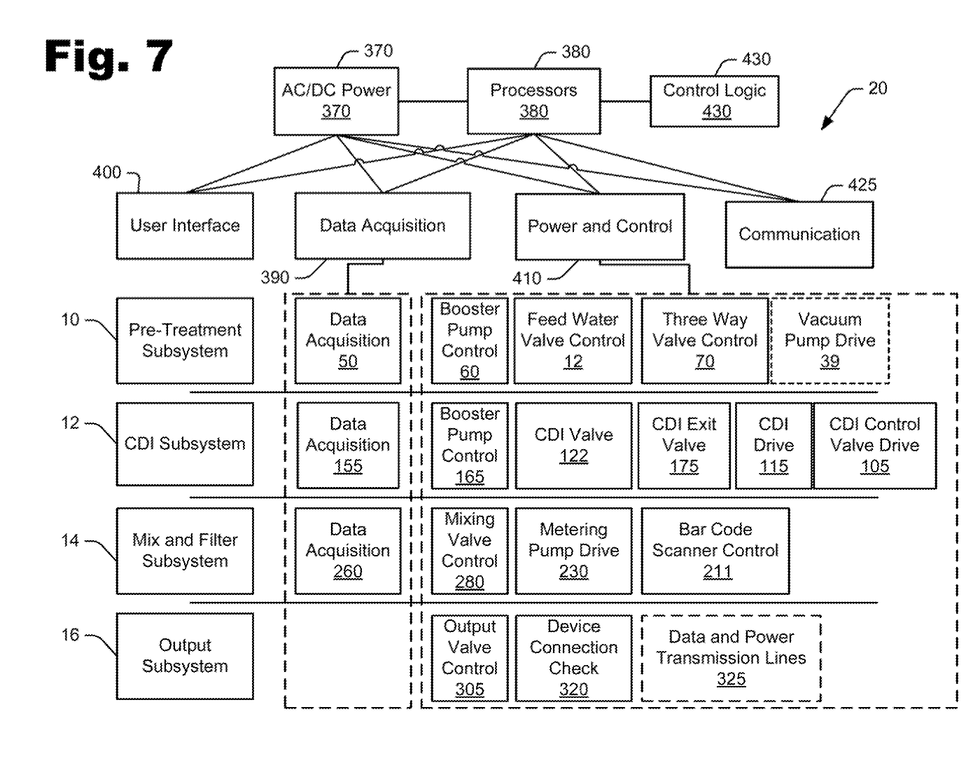

FIG. 7 illustrates an example electrical subsystem 20. The electrical subsystem 20 provides a means for executing logic, acquiring data from mechatronic sensors, powering actuators, and providing a user interface. In an example, the filter station electrical subsystem 20 includes AC/DC medical grade power supply and power 370, processors 380, data acquisition circuits 390, user interface (e.g., touchscreen display and graphical user interface) 400, power and control circuits 410, communications (e.g., wireless communication transceiver) 425, and control logic 430.

In an example, power enters the AC/DC medical grade power supply 370. The power is converted from alternating current to direct current in a manner compliant with medical device standards. The processors 380 are powered by the DC power from the power supply 370. The processors 380 execute the logic and safety measures to run the device based on the control logic 430. The data acquisition circuits 390 are powered by the power supply 370. The circuits 390 convert analog information from the sensors in the system to digital signals for the processors 380.

In an example, the user interface 400 is powered by the power supply 370, and displays graphics as instructed by the processor 380 and control logic 430 to output the graphical user interface. The touchscreen 400 communicates physical touch commands from the user to the processor 380. The control logic 430 instructs the system based on the user commands.

In an example, power and control circuits 410 are powered by the power supply 370. These circuits energize the actuators, receive feedback from the actuators, and control the position of the actuators. The control logic 430 is a set of instructions that run on the processor 380.

The wireless communication transceiver 425 sends and receives data between the Transportable Water Purification System and local area network. It is powered by the power supply 370 and communicates information to and from the processor 380.

The pressure drop across (e.g., pressure before minus pressure after) a filter is known at a given flow rate. The system measures the pressure drop across all filters (sediment filter, ultrafilter, air removal filter) and compares to known values. If the system observes that the pressure drop approaches the maximum acceptable value (indicating a fouled filter), the user is notified that filter replacement may be needed shortly. If the pressure drop exceeds the acceptable value, the Stationary Filter may stop functioning until the filters are replaced.

The device may be connected to the internet and send a signal to the manufacturer when the pressure drops approach the acceptable limit, This may trigger an automated reorder of the filter and shipment to the user.

The system maintains usage data. This data may be stored on the Transportable Water Purification System, on an email account, on a local device via Ethernet, a server location, remote data storage via cell phone connection, or an EMR database.

The data may include the following. Batch details, including time- and batch-stamped measurements for all sensors. Case details, including user profile selection, patient name, end effectors used, flow rates and pressures from the mobile tank, type of fluid used, and amount of fluid used. System errors, faults. messages. Maintenance Status, including filter life, total volume of fluid purified, number of batches created, etc.

The user may select the temperature of the water, up to about 40° C. This enables the use to select a fluid temperature best suited for the patient and the therapy provided.

It is noted that the examples shown and described are provided for purposes of illustration and are not intended to be limiting. Still other examples are also contemplated.

1. A water purification system, comprising.
a pre-treatment subsystem;
a Capacitive Deionization (CDI) subsystem;
a mix and filter subsystem; and
an output subsystem.

2. The water purification system of claim 1, further comprising a mechanical subsystem to support the pre-treatment subsystem, CDI subsystem, mix and filter subsystem, and the output subsystem.

3. The water purification system of claim 1, further comprising an electrical subsystem to support the pre-treatment subsystem, CDI subsystem, mix and filter subsystem, and the output subsystem.

4. The water purification system of claim 1, further comprising a transportable water machine to house at least one of the subsystems.

5. The water purification system of claim 1, further comprising CDI drive circuits of the CDI subsystem configured to control power to electrodes and cause ions and/or chemicals to desorb from electrode surfaces.

6. The water purification system of claim 1, wherein fluid in a CDI chamber of the CDI subsystem is deionized.

7. The water purification system of claim 6, further comprising electrodes in the CDI chamber, wherein current is passed across the electrodes.

8. The water purification system of claim 7, wherein an internal resistance of the electrodes generate heat, and fluid flowing adjacent the electrodes is heated by convective heat transfer from the electrodes.

9. The water purification system of claim 1, wherein heating electrode above a temperature threshold heats fluid during purification to create a sterile solution at a predetermined temperature and further disinfects the system.

10. The water purification system of claim 1, further comprising a non-contact identification method to read information from a concentrate solution label.

11. The water purification system of claim 1, further comprising an ultrafilter configured to remove bacteria, virus, and endotoxin from a fluid, wherein a pore diameter of the ultrafilter is less than about 0.22 micron.

12. A transportable water machine to generate purified water for medical application, comprising.
fluid treatment subsystems including at least a pre-treatment subsystem, a Capacitive Deionization (CDI) subsystem, a mix and filter subsystem, and an output subsystem;
a mechanical subsystem to support the pre-treatment subsystem, CDI subsystem, mix and filter subsystem, and the output subsystem; and
an electrical subsystem to support the pre-treatment subsystem, CDI subsystem, mix and filter subsystem, and the output subsystem.

13. The transportable water machine of claim 12, further comprising CDI drive circuits of the CDI subsystem configured to control power to electrodes and cause ions and/or chemicals to desorb from electrode surfaces.

14. The transportable water machine of claim 12, wherein fluid in a CDI chamber of the CDI subsystem is deionized.

15. The transportable water machine of claim 14, further comprising electrodes in the CDI chamber, wherein current is passed across the electrodes, wherein an internal resistance of the electrodes generate heat, and fluid flowing adjacent the electrodes is heated by convective heat transfer from the electrodes.

16. The transportable water machine of claim 12, wherein heating electrode above a temperature threshold heats fluid during purification to create a sterile solution at a predetermined temperature and further disinfects the system.

17. The water purification system of claim 1, further comprising an ultrafilter configured to remove bacteria, virus, and endotoxin from a fluid, wherein a pore diameter of the ultrafilter is less than about 0.22 micron.

18. A method of treating fluid with a water purification system, comprising:
receiving influent fluid to a pre-treatment subsystem;
receiving effluent fluid from the pre-treatment subsystem in a Capacitive Deionization (CDI) subsystem;
receiving effluent fluid from the CDI subsystem in a mix and filter subsystem;
receiving effluent fluid from the mix and filter subsystem in an output subsystem; and
removing large particles, ions, organic molecules, inorganic molecules, and biological material from the influent fluid.

19. The method of claim 18, further comprising a mechanical subsystem supporting the pre-treatment subsystem, CD subsystem, mix and filter subsystem, and the output subsystem.

20. The method of claim 18, further comprising an electrical subsystem supporting the pre-treatment subsystem, CDI subsystem, mix and filter subsystem, and the output subsystem.
